(19) United States
(12) Patent Application Publication
(10) Pub. No.: US 2014/0196837 A1
(43) Pub. Date: Jul. 17, 2014

(54) METHOD OF INTEGRALLY FORMING RIBS IN A COMPOSITE PANEL

(71) Applicant: GM GLOBAL TECHNOLOGY OPERATIONS LLC, Detroit, MI (US)

(72) Inventors: Joseph M. Polewarczyk, Rochester Hills, MI (US); Paul E. Krajewski, Troy, MI (US)

(73) Assignee: GM GLOBAL TECHNOLOGY OPERATIONS LLC, Detroit, MI (US)

(21) Appl. No.: 13/741,417

(22) Filed: Jan. 15, 2013

(51) Int. Cl. B29C 65/00

(52) U.S. Cl. CPC B29C 65/002
USPC 156/196; 264/334; 264/258

(57) ABSTRACT

A method of integrally forming a composite rib structure includes positioning a first fiber sheet on a pre-preg mold, the pre-preg mold including a first channel and a second channel separated by a wedge-shaped protrusion, and the fiber sheet including a plurality of fibers oriented along a first common direction. The method further including extending the wedge-shaped protrusion through the first fiber sheet such that a subset of the plurality of fibers are displaced about the protrusion and into each of the respective first channel and second channel; applying a resin within each of respective first channel and second channel to the plurality of fibers; pre-curing the resin to form a pre-preg rib structure within the channels; and removing the pre-preg rib structure from the pre-preg mold.

### TECHNICAL FIELD

The present invention relates generally to composite part forming techniques.

### BACKGROUND

Composite materials are typically formed by embedding a high-tensile strength fibrous material within a epoxy/resin matrix which is then solidified or polymerized to create the composite. An intermediate forming step to the final creation of the composite material often involves creating a pre-preg composite part. Pre-preg is a term for “pre-impregnated” composite fibers where a material, such as epoxy is already present. These usually take the form of a weave or are uni-directional. The pre-preg already contains an amount of the matrix material used to bond the fibers together. The resin, however is only partially cured to allow easy handling.

Carbon-fiber composite is an example of one composite material that is used in manufacturing applications. It is favored for its high strength and light weight properties. Typical carbon-fiber part forming techniques involve forming a rough part in an initial step, and machining necessary features into the rough part (via material removal) in a subsequent step. Examples of subsequent machining may include drilling holes, planning surfaces, and milling cavities (e.g., between stiffening ribs). These machining processes, however, may sever integral fibers and compromise the integrity and/or strength of the finished part.

### SUMMARY

A method of integrally forming a composite rib structure includes positioning a first fiber sheet on a pre-preg mold. The pre-preg mold includes a first channel and a second channel that are separated by a wedge-shaped protrusion. Additionally, the fiber sheet includes a plurality of fibers oriented along a first common direction. In one configuration, the plurality of fibers of the first fiber sheet may be carbon fibers.

Once positioned, the method further includes extending the wedge-shaped protrusion through the first fiber sheet such that a subset of the plurality of fibers are displaced about the protrusion and into each of the respective first channel and second channel. Once the fibers are aligned and positioned within the channel, a resin may be applied within each of respective first channel and second channel to the plurality of fibers. The resin may be pre-cured to form a pre-preg rib structure within the channels, which may then be removed from the pre-preg mold. The step of extending the wedge-shaped protrusion through the first fiber sheet may be characterized by not severing any of the plurality of fibers.

In one embodiment, the method may further include positioning a second fiber sheet on the pre-preg mold prior to applying the resin. The second fiber sheet may include a second plurality of fibers oriented along a second common direction, and the pre-preg mold may include a third channel and a fourth channel separated by the wedge-shaped protrusion. Each of the third channel and fourth channel may be disposed at an angle to the respective first channel and second channel. The wedge-shaped protrusion may be extended through the second fiber sheet such that a subset of the second plurality of fibers are displaced about the protrusion and into each of the respective third channel and fourth channel. Likewise, the resin may be applied within each of respective third channel and fourth channel to the plurality of fibers.

The wedge-shaped protrusion may include at least one of a conical portion and a pyramidal portion, that may be configured to pierce through the first fiber sheet and the second fiber sheet.

The method may further include inserting the pre-preg rib structure into a part mold; overlaying the pre-preg rib structure with a composite pre-preg panel; curing the pre-preg rib structure and the composite pre-preg panel within the part mold to fuse the pre-preg rib structure with the composite pre-preg panel. Curing the pre-preg part within the part mold may include heating and/or applying pressure to the pre-preg part.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a flow diagram illustrating a method of forming a rib in a composite panel.

FIG. 2 is a schematic perspective view of a pre-preg mold having a plurality of wedge-shaped protrusions defining a respective plurality of channels, and a fiber sheet disposed above the pre-preg mold.

FIG. 3 is a schematic perspective view of the pre-preg mold of FIG. 2, with the fiber sheet disposed in the plurality of channels.

FIG. 4 is a schematic perspective view of the pre-preg mold of FIG. 3 with a resin applied to the fiber sheet.

FIG. 5 is a schematic perspective view of a pre-impregnated composite part, such as made from the assembly of FIG. 4.

FIG. 6 is a schematic exploded view of the pre-impregnated composite part of FIG. 5, being fused with a composite panel in a final mold.

FIG. 7 is a schematic perspective view of the pre-preg mold of FIG. 2, with a plurality of fiber sheets disposed above the mold.

### DETAILED DESCRIPTION

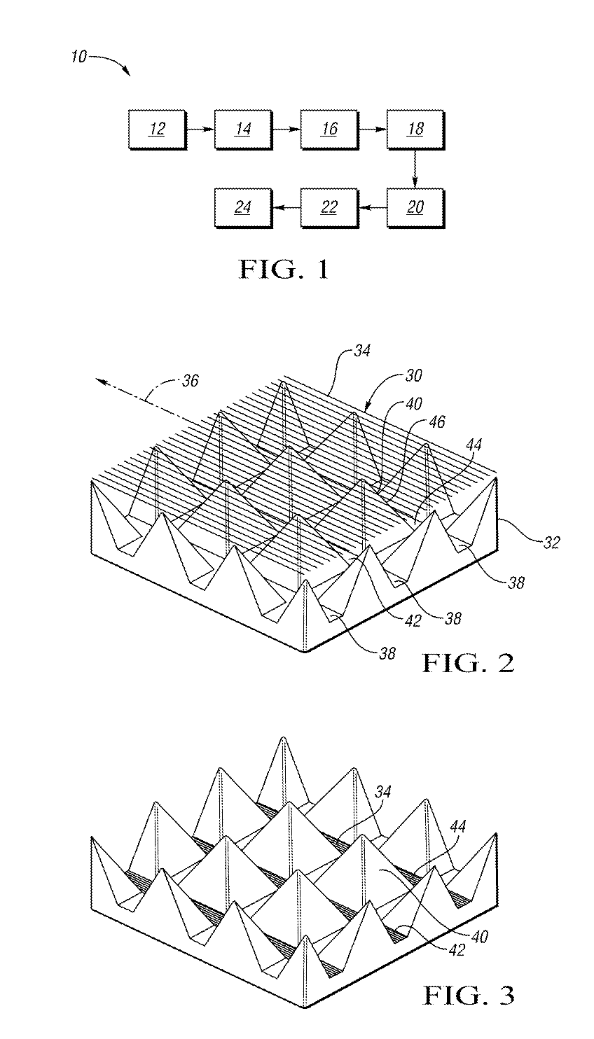

Referring to the drawings, wherein like reference numerals are used to identify like or identical components in the various views, FIG. 1 schematically illustrates a method 10 of forming ribs in a composite panel. The method 10 begins at step 12 when a fiber sheet 30 is positioned on a pre-preg mold 32, as shown in FIG. 2. The fiber sheet 30 may be formed from a plurality of individual fibers 34 that may include, for example, spun glass fibers, carbon fibers, graphite fibers or other suitable high-tensile strength fiber materials. Each individual fiber may have a thickness/diameter of approximately 5-10 μm and lengths between 10 cm and 1 m. In other configurations, however, the fibers may have larger or smaller thicknesses/lengths, and the previous examples should not be limiting.

The fiber sheet 30 may generally be a thin sheet of fiber-based fabric where numerous fibers are oriented within a single plane, or within approximately 1-2 mm of a common plane. In one configuration, the fiber sheet 30 may include a plurality of fibers 34 that are longitudinally aligned in a common direction 36. For example, the fiber sheet 30 may be a unidirectional array of fibers, with a majority of the fibers oriented along the common direction 36 (a few fibers may occasionally be oriented in a perpendicular direction to hold the unidirectional array in position).

The pre-preg mold 32 may be a solid table that may be used to form a pre-impregnated (“pre-preg”) composite rib structure. The pre-preg mold 32 may define a plurality of channels 38 that may be used to construct the rib structure itself. Once formed, the rib structure may be fused and/or molded with a composite panel to form a structurally reinforced panel. In very general terms, any pre-impregnated composite part (whether formed in a rib-pattern or another form) may be a “blank” that may be used in subsequent molding processes to form a part with more complex geometry. Likewise, multiple pre-preg “blanks” may be molded together using normal molding techniques, whereafter a final curing process may fuse the multiple pre-pregs together in a single part.

The pre-preg mold 32 may include one or more wedge-shaped protrusions 40 that extend outward from a portion of the mold 32, and may partially define a first channel 42 and a second channel 44. The wedge-shaped protrusion 40 may include a conical or pyramidal portion 46 that may be on the distal end of the protrusion 40. Likewise, below the conical or pyramidal portion 46, there may be a base portion that includes parallel walls that provide the lower portion of the channels 42, 44 with a constant cross-sectional width from top to bottom (i.e., to provide a formed rib with a rectangular cross-sectional area rather than a trapezoidal or triangular cross-sectional area).

Referring again to FIG. 1, after the fiber sheet 30 is positioned on the pre-preg mold 32 in step 12, the wedge-shaped protrusion 40 may be extended through the fiber sheet 30 in step 14 such that a subset of the plurality of fibers 34 are displaced about the protrusion 40 and into each of the first channel 42 and the second channel 44. The conical/pyramidal portion 46 of the forming tool 40 may include a sufficiently sharp point on its distal end to cleanly divide the fibers without intentionally cutting or severing any of the fibers extending along the common direction 36. As the forming tool 40 is extended through the plurality of fibers 34, the gradually increasing width of the conical/pyramidal portion 46 may separate the fibers such that they are displaced on either side of the protrusion 40 as the fiber sheet 30 is forced progressively lower into the mold 32 and/or channels, as shown in FIG. 3.

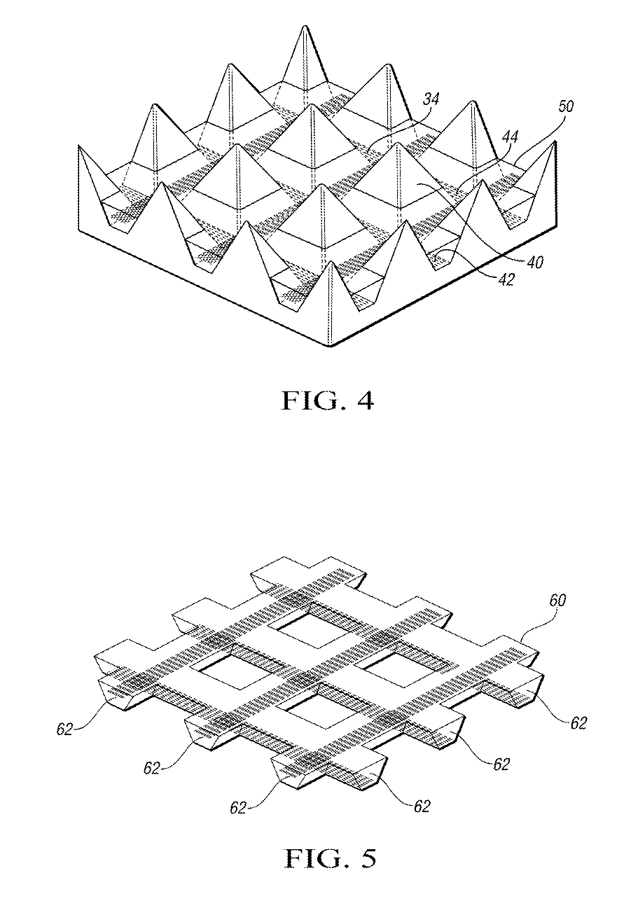

After the fiber sheet 30 is positioned on the pre-preg mold 32 with the fibers disposed in the channels 42, 44, and forming tool 40 extending between the plurality of fibers 34, in step 16 (FIG. 1) an epoxy/resin 50 may be applied to the fibers 30 in each of the respective first channel 42 and second channel 44. The resin 50 may flow between the fibers, as generally shown in FIG. 4, where it may be partially cured or pre-cured in step 18 to firm the resin about the fibers and form the pre-preg rib structure 60. In this state, the fibers may be suspended within the resin matrix and the resin matrix may be solidified to a point where it may be handled. The pre-curing process may involve, for example, heating the resin/epoxy to a temperature lower than a final curing temperature, though above ambient. For example, with a resin that may be finally cured at 300 degrees Celsius, the pre-curing may take place by heating the resin to 100 degrees Celsius, and/or for a shorter duration of time.

Once the pre-preg rib structure 60 is sufficiently pre-cured to allow it to be handled without a loss of structural integrity or further flowing of the resin 50 while at room temperature, it may be removed from the pre-preg mold 32 (step 20). In this manner, as shown in FIG. 5, the pre-preg rib structure 60 may define a plurality of ribs 62 that may extend in a pre-defined pattern, and at various angles to each other. Each subset of the plurality of displaced fibers 34 may be aligned with a respective rib such that the fibers remain uncut along the length of the rib. This method of manufacture/part fabrication is in stark contrast to other methods of fabrication, where voids in-between the respective ribs are cut, milled, or otherwise machined into a cured part. With those post-processing techniques, it is difficult to ensure that the fibers remain uncut, particularly if the rib includes a curvature. As appreciated, any breaks or discontinuities of the fibers along the length of the rib may adversely affect the structural integrity of the part.

As schematically illustrated in FIG. 5, after the initial forming of the pre-preg rib structure 60 in steps 12 through 20, the pre-preg rib structure 60 may be inserted in a final mold 70 (step 22), for example, with one or more pre-preg composite panels 72. The pre-preg composite panel 72 may be a continuous sheet of unidirectional or woven carbon fiber that is impregnated and pre-cured with an epoxy/resin. Once in the final mold, the collection of pre-preg parts 60, 72 may be finally cured through the application of heat and/or temperature (step 24). In doing so, the rib structure 60 may fuse with the panel 72 to provide a structural reinforcement to the panel 72 against bending.

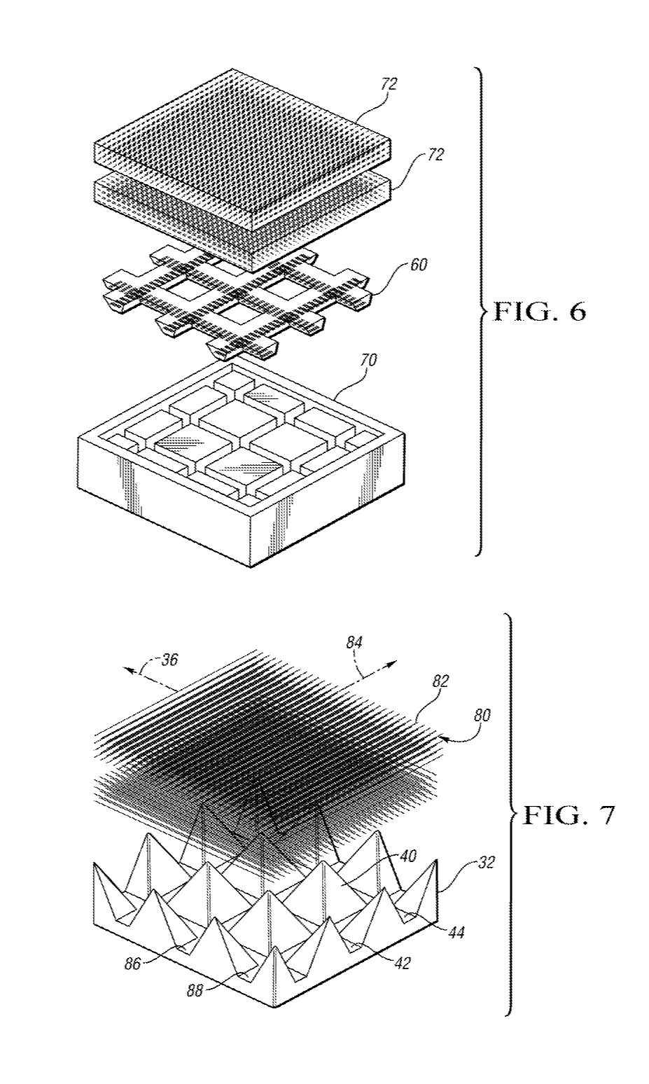

In an extension of this methodology, prior to the application of the resin 50 in step 16, one or more additional fiber sheets 80 may be layered over the initially placed fiber sheet 30. For example, as generally illustrated in FIG. 6, a second fiber sheet 80 may be placed above the first fiber sheet 30. The second fiber sheet 80 may be similar in construction as compared to the first fiber sheet 30, with a plurality of fibers 82 substantially oriented along a second common direction 84. The second fiber sheet 80 may be placed on the pre-preg mold 32 such that the second common direction 84 is substantially aligned with a third and a fourth channel 86, 88 that may be respectively defined by the pre-preg mold 32. The third and fourth channels 86, 88 may be separated by the wedge-shaped protrusion 40, which may intersect with the wedge-shaped protrusion used to separate the first and a second channels 42, 44. Each of the third and fourth channels 86, 88 may be disposed at an angle relative to the respective first and second channels 42, 44 to provide bending rigidity to the finally molded part along multiple different bending axes. Once in position, the resin 50 may be applied into each of the first through fourth channels to form the pre-preg rib structure.

Using the methodology described herein, it may be possible to create complex rib patterns that may be subsequently molded/fused with a pre-preg composite panel. For example, this technique may be used to create ribs that may outline the perimeter of the pre-preg composite panel, ribs that may specifically extend along load-transfer planes, such as between mounting points. Similarly, rib patterns may be constructed that form triangles or squares between each other. In each instance, however, unidirectional fibers may be separated into channels using one or more wedge-shaped protrusions that may divide and align the fibers without intentionally severing them.

The present methods are equally applicable to both thermoset and thermoplastic composite materials, and absent specific statements to the contrary, nothing described herein should be read to limit the nature of the substrate. Likewise, while the present figures illustrate the creation of a regular, grid-like rib structure, the present methods may be used to form more unique and/or complex parts. For example, the present methods may be used to form a structure where stiffening ribs are aligned around the perimeter of a component, with one or more interior ribs being located along specific loading axes.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. A method of integrally forming a composite rib structure comprising:
positioning a first fiber sheet on a pre-preg mold, the pre-preg mold including a first channel and a second channel separated by a wedge-shaped protrusion, the fiber sheet including a plurality of fibers oriented along a first common direction;
extending the wedge-shaped protrusion through the first fiber sheet such that a subset of the plurality of fibers is displaced about the protrusion and into each of the respective first channel and second channel;
applying a resin within each of the respective first channel and second channel to the plurality of fibers;
pre-curing the resin to form a pre-preg rib structure within the channels; and
removing the pre-preg rib structure from the pre-preg mold.

2. The method of claim 1, further comprising:
positioning a second fiber sheet on the pre-preg mold prior to applying the resin, the second fiber sheet including a second plurality of fibers oriented along a second common direction, the pre-preg mold including a third channel and a fourth channel separated by the wedge-shaped protrusion and each disposed at an angle to the respective first channel and second channel;
extending the wedge-shaped protrusion through the second fiber sheet such that a subset of the second plurality of fibers are displaced about the protrusion and into each of the respective third channel and fourth channel; and
applying a resin within each of respective third channel and fourth channel to the plurality of fibers.

3. The method of claim 2, wherein the wedge-shaped protrusion includes at least one of a conical portion and a pyramidal portion, and wherein the at least one of a conical portion and a pyramidal portion is configured to pierce through the first fiber sheet and the second fiber sheet.

4. The method of claim 1, further comprising:
inserting the pre-preg rib structure into a part mold;
overlaying the pre-preg rib structure with a composite pre-preg panel;
curing the pre-preg rib structure and the composite pre-preg panel within the part mold to fuse the pre-preg rib structure with the composite pre-preg panel.

5. The method of claim 3, wherein curing the pre-preg part within the part mold includes heating and applying pressure to the pre-preg part.

6. The method of claim 1, wherein the step of extending the wedge-shaped protrusion through the first fiber sheet is characterized by not severing any of the plurality of fibers.

7. The method of claim 1, wherein the plurality of fibers of the first fiber sheet are carbon fibers.

8. A method of integrally forming a composite panel with a composite rib structure comprising:
positioning a first fiber sheet on a pre-preg mold, the pre-preg mold including a first channel and a second channel separated by a wedge-shaped protrusion, the fiber sheet including a plurality of fibers oriented along a first common direction;
extending the wedge-shaped protrusion through the first fiber sheet such that a subset of the plurality of fibers is displaced about the protrusion and into each of the respective first channel and second channel;
applying a resin within each of the respective first channel and second channel to the plurality of fibers;
pre-curing the resin to form a pre-preg rib structure within the channels; and
removing the pre-preg rib structure from the pre-preg mold;
inserting the pre-preg rib structure into a part mold;
overlaying the pre-preg rib structure with a composite pre-preg panel; and
curing the pre-preg rib structure and the composite pre-preg panel within the part mold to fuse the pre-preg rib structure with the composite pre-preg panel.

9. The method of claim 8, further comprising:
positioning a second fiber sheet on the pre-preg mold prior to applying the resin, the second fiber sheet including a second plurality of fibers oriented along a second common direction, the pre-preg mold including a third channel and a fourth channel separated by the wedge-shaped protrusion and each disposed at an angle to the respective first channel and second channel;
extending the wedge-shaped protrusion through the second fiber sheet such that a subset of the second plurality of fibers are displaced about the protrusion and into each of the respective third channel and fourth channel; and
applying a resin within each of respective third channel and fourth channel to the plurality of fibers.

10. The method of claim 9, wherein the wedge-shaped protrusion includes at least one of a conical portion and a pyramidal portion, and wherein the at least one of a conical portion and a pyramidal portion is configured to pierce through the first fiber sheet and the second fiber sheet.

11. The method of claim 8, wherein curing the pre-preg part within the part mold includes heating and applying pressure to the pre-preg part.

12. The method of claim 8, wherein the step of extending the wedge-shaped protrusion through the first fiber sheet is characterized by not severing any of the plurality of fibers.

13. The method of claim 8, wherein the plurality of fibers of the first fiber sheet are carbon fibers.

14. A method of integrally forming a composite panel with a composite rib structure comprising:
positioning a first fiber sheet on a pre-preg mold, the pre-preg mold including a first channel and a second channel separated by a wedge-shaped protrusion, the fiber sheet including a plurality of fibers oriented along a first common direction;
positioning a second fiber sheet on the pre-preg mold prior to applying the resin, the second fiber sheet including a second plurality of fibers oriented along a second common direction, the pre-preg mold including a third channel and a fourth channel separated by the wedge-shaped protrusion and each disposed at an angle to the respective first channel and second channel;
extending the wedge-shaped protrusion through each of the first fiber sheet and second fiber sheet such that a subset of the plurality of fibers is displaced about the protrusion and into each of the respective first channel, second channel, third channel, and fourth channel;
applying a resin within each of the respective first channel, second channel, third channel, and fourth channel to the plurality of fibers;
pre-curing the resin to form a pre-preg rib structure within the channels; and
removing the pre-preg rib structure from the pre-preg mold;
inserting the pre-preg rib structure into a part mold;
overlaying the pre-preg rib structure with a composite pre-preg panel; and
curing the pre-preg rib structure and the composite pre-preg panel within the part mold to fuse the pre-preg rib structure with the composite pre-preg panel.

15. The method of claim 14, wherein the wedge-shaped protrusion includes at least one of a conical portion and a pyramidal portion, and wherein the at least one of a conical portion and a pyramidal portion is configured to pierce through the first fiber sheet and the second fiber sheet.

16. The method of claim 14, wherein curing the pre-preg part within the part mold includes heating and applying pressure to the pre-preg part.

17. The method of claim 14, wherein the step of extending the wedge-shaped protrusion through the first fiber sheet is characterized by not severing any of the plurality of fibers.

18. The method of claim 14, wherein the plurality of fibers of the first fiber sheet are carbon fibers.
